(19) United States
(12) Patent Application Publication
(10) Pub. No.: US 2013/0076174 A1
(43) Pub. Date: Mar. 28, 2013

(54) ELECTRIC DRIVE ASSEMBLY

(71) Applicants: Norbert Wibben, Salzbergen (DE); Norbert Kötting, Neuenkirchen (DE); Karl Stermann, Horstel (DE); Fabio Bertolotti, Bad Bentheim (DE)

(72) Inventors: Norbert Wibben, Salzbergen (DE); Norbert Kötting, Neuenkirchen (DE); Karl Stermann, Horstel (DE); Fabio Bertolotti, Bad Bentheim (DE)

(73) Assignee: SSB WIND SYSTEMS GMBH & CO. KG, Salzbergen (DE)

(21) Appl. No.: 13/700,914

(22) PCT Filed: Apr. 19, 2011
(86) PCT No.: PCT/EP11/56204

§ 371 Date: Nov. 29, 2012

(30) Foreign Application Priority Data
Jun. 2, 2010 (DE) 10 2010 017 222.7

(51) Int. Cl. H02K 9/04; H02K 5/22

(52) U.S. Cl. CPC H02K 9/04; H02K 5/22
USPC 310/64

(57) ABSTRACT

The disclosure describes an electric drive assembly having an electric motor which is arranged in a motor housing and a fan which is arranged on an end face of the motor housing. The fan generates a cooling air flow that removes heat from the electric motor. An electronic controller with electronic components controls or regulates the electric motor. A box-shaped motor panel sits on the motor housing and houses the electronic components. The heat generated during operating of the electronic components can be discharged by means of the motor panel to a heat sink which is in thermally conductive contact with the motor panel.

The invention relates to an electric drive arrangement having an electric motor, which is arranged in a motor housing, a fan arrangement arranged on an end face of the motor housing and comprising a fan, by means of which a cooling air flow dissipating heat losses of the electric motor can be generated, electronic components, by means of which the electric motor can be controlled or regulated, and at least one box-shaped motor panel which rests on the motor housing and accommodates the electronic components. The invention further relates to a cooling device for a drive arrangement and to an electric blade angle adjustment drive having a drive arrangement.

Modern wind turbines comprise rotor blades pivot-mounted on a rotor, wherein by means of an individual change in the blade angle relatively for each rotor blade an angle of attack of the wind can be varied. An associated blade angle adjustment drive (pitch drive) is usually arranged near or directly on the bearing of the rotor blade to be adjusted, or in the rotor itself, and comprises an electric motor having mechanical adjustment elements for the respective rotor blade.

Electronic components are assigned to the motor, by means of which control and/or regulation of the motor, in particular control and/or regulation of the motor shaft at an appropriate angle, are carried out. These electronic components are accommodated in a box-shaped housing or control box, which is referred to here as a motor panel or box-shaped motor panel, wherein the motor panel is usually directly fixed to the motor housing, either attached to the lateral surface of the motor housing (axial arrangement) or fastened to an end face of the motor housing (radial arrangement).

The axial arrangement of the motor panel has the advantage that it is simpler in terms of the mechanical design, ensures a more uniform and quicker air flow and involves no losses with respect to the overall length and a simpler attachment to the motor. Motor and motor panel require a cooling device during operation, in order to dissipate the heat which accumulates in operation. A fan arrangement is usually used for the motor for this purpose, which is either arranged on an end face of the motor housing or transversely to it.

The invention preferably takes as its starting point the end-face fan arrangement and the axial motor panel arrangement on the motor, since this design ensures that the cooling air flow is conveyed in an optimum and effective way. The cooling air flow can be conveyed along the whole motor surface without elaborate deflection elements being required. The electronic components arranged in the motor panel are cooled by cooling elements or separate fans which are either directly or indirectly combined with the motor ventilation.

DE 196 18 996 A1 shows an electric machine having an air blower arranged on the end face and a terminal box resting on the machine housing. The terminal box accommodates the electronic components and has an opening in the direction of the air blower. A partial air flow of the air blower is conveyed in a targeted way, by means of a branch channel arranged over the fan housing, via the open side to the terminal box, so that in this way the heat losses of the components in the box can be dissipated. The terminal box is firmly connected to the machine housing.

DE 197 03 655 C2 shows an electric drive having a motor and having power electronics arranged on the circumference of the motor in the axial direction. A fan is arranged on an end face of the motor, wherein a partial air flow of the fan flow is conducted in an annulus between the motor housing and an outer housing casing.

EP 1 511 156 A2 shows an optimised cooling air feed for an electric motor, having a box for the power electronics, which is attached to the outer wall of the motor, and having a fan which is attached to the end face of the motor. The supporting surface of the box pointing in the direction of the motor has cooling fins for the power electronics on a subarea with an opening in the box base in the direction of the motor housing. An annularly attached fan channel is provided between the motor housing and the box base, in which devices for distributing the cooling air of the fan to the power electronics are provided, these devices conducting the cooling air flow into the power electronics area.

U.S. Pat. No. 5,763,969 A shows an electric motor having attached power electronics and a fan arrangement arranged on the end face of the motor. The power electronics are arranged in a box which is open at its base facing the motor housing and is provided with cooling fins there which ensure that there is a thermal separation between the motor housing and the power electronics. A part of the fan flow of the motor fan flows between the fins.

For application in pitch drives in wind turbines, the cooling devices known from the prior art are not advantageous for the motors, since they do not—due to the confined space conditions in the rotor hub of the wind turbine—ensure that heat is optimally dissipated from the motor and the motor panel, attached to the motor, with its electronic components arranged there. The cooling fins of the electronic components being directly cooled by a partial air flow of the fan causes vibrations of the motor in operation to be almost directly transferred to the partly sensitive electronic components arranged in the motor panel. This effect particularly occurs when carrying out a braking process of an angularly controlled electric drive in wind turbines, as is the case with pitch systems. Here, the drive shaft of the electric motor is braked by means of a braking device and/or held fast and subsequently released again. These processes produce strong vibrations both in the motor and in the motor panel, which can result in malfunctions in the electronic components arranged in the motor panel.

DE 197 04 226 B4 shows an electric motor having a motor panel which is axially arranged on the longitudinal wall of the motor and in which the signal and power electronics are accommodated. The motor on the end face has a fan, the cooling air of which only cools the motor. Between the motor housing and the motor panel an axially extending intermediate part is provided which is directly attached to the motor housing and is thermally insulated on the side facing the motor panel. The motor panel protrudes laterally beyond the intermediate part. A heat sink formed by cooling fins is only provided on the protruding surface of the motor panel pointing towards the motor, this heat sink being in close thermal contact with the power electronics and being thermally separated by a heat barrier with respect to the motor panel.

If a plurality of electronic power components, which are spaced apart from one another, is to be cooled, then each of these must be brought into contact with the heat sink. To that end, a hole in the heat barrier and a hole in the motor panel must be provided for each of the components to be cooled, wherein the latter hole in the motor panel must additionally be sealed, so that dirt and moisture can be prevented from penetrating the motor panel. This is associated with a relatively high amount of manufacturing effort and expense.

Taking this as the starting point, the invention is based on the object of further developing a subject matter of the type mentioned at the outset in such a way that a plurality of electronic components can be cooled with less manufacturing effort and expense. Preferably, with good or improved cooling the transfer of damaging vibrations to the motor panel should, in addition, be able to be prevented or at least reduced. Preferably, in respect of the preferred use of the subject matter mentioned at the outset, there is furthermore the requirement for the motor panel to be able to be simply and easily detached from the motor housing and replaced.

This object is achieved according to the invention with an electric drive arrangement according to Claim 1 and with a cooling device according to Claim 26. Advantageous further embodiments of the invention are given in the sub-claims.

The electric drive arrangement according to the invention comprises an electric motor, which is arranged in a motor housing, a fan arrangement arranged on an end face of the motor housing and having a fan, by means of which a cooling air flow dissipating heat losses of the electric motor can be generated, electronic components, by means of which the electric motor can be controlled and/or regulated, and at least one box-shaped motor panel, which rests on the motor housing and accommodates the electronic components, wherein heat generated when the electronic components are in operation can be discharged by means of the motor panel to a heat sink which is in thermoconducting contact with the motor panel.

Heat arising when the electronic components are in operation is hence discharged to the heat sink by interconnecting the motor panel, so that no direct contact is required between the components to be cooled and the heat sink. The manufacturing effort and expense required for providing holes, for sealing them and for providing a heat barrier can therefore be avoided or at least reduced.

At the same time, however, the invention also makes it possible for at least one of the components to be provided with at least one additional heat sink, if the at least one component discharges a relatively large amount of heat. The at least one component is preferably indirectly or directly in thermoconducting contact with the at least one additional heat sink, wherein the at least one additional heat sink is arranged e.g. protruding from the motor panel or outside of or on an outer wall of the motor panel. Nevertheless, the manufacturing effort and expense is still reduced, since no holes have to be provided and sealed in the motor panel for the other components. The at least one additional heat sink can e.g. comprise cooling fins or be formed by these.

The heat arising when the electronic components provided in the motor panel are in operation is preferably dissipated by convection, preferably exclusively by convection. The transfer of vibrations associated with the cooling air flow with direct cooling of the electronic components can consequently be prevented or at least reduced.

The heat sink is preferably firmly connected to the motor housing. In particular, the motor panel is attached in a detachable manner to the heat sink. Preferably, by interconnecting the heat sink the motor panel is connected in a separable manner to the motor housing. Thus, the motor panel is cooled, and hence also the heat, arising when the electronic components are in operation, is dissipated, by the motor panel being in thermoconducting contact with the heat sink which is firmly connected to the motor housing and which is preferably cooled by the cooling air flow generated by the fan provided on the end face of the motor housing. Preferably, the cooling air flow cools the motor housing which cools the heat sink, so that the heat sink is in particular indirectly cooled by the cooling air flow. Since the motor panel preferably can be separated from the heat sink, and hence in particular also from the motor housing, the motor panel can also be easily replaced.

The proposed indirect cooling method of the motor panel, combined with mounting it on the motor housing, not only produces optimum protection from heat but also reduces the transfer of motor vibrations to the electronic components arranged in the motor panel. The motor panel is consequently thermally coupled to the motor housing and, at the same time, is optimally mounted. The invention therefore provides an optimum combination of heat and vibration protection for the electric drive arrangement.

Preferably, due to the detachable connection between the motor panel and the heat sink, opening the motor panel at the place of installation is no longer necessary. The motor panel can preferably be detached from the motor housing and the heat sink without the motor panel having to be opened. In particular, devices for opening the motor panel are no longer required. This enables space to be saved with regard to the arrangement and enables the electronic components to be fitted simply in terms of manufacture within the motor panel. It can therefore be implemented sealed on all sides, whereby moisture and dirt can be largely prevented from penetrating it. When the motor panel is removed, the heat sink remains on the motor housing. If a fault or a malfunction is reported by a central monitoring station, the motor panel can be easily replaced. The risk of mixing up internal and external wiring of the motor panel during replacement is reduced. This is particularly important with regard to the confined space conditions at the place where the drive arrangement is installed in a rotor hub of a wind turbine.

Preferably, the heat sink is permanently firmly connected to the motor housing. Preferably, the heat sink is rigidly connected to the motor housing. By way of example, the heat sink is connected to the motor housing in a force-fit and/or form-fit and/or firmly bonded manner. In particular, the heat sink is integrally formed with the motor housing. Preferably, the heat sink forms a material unit with the motor housing or with an outer housing wall of the motor housing.

The heat sink preferably has a supporting surface facing the motor panel and via this supporting surface is in thermoconducting contact with the motor panel. The supporting surface of the heat sink is preferably formed flat. The motor panel preferably has a supporting surface facing the heat sink which in particular is in thermoconducting contact with the supporting surface of the heat sink. The supporting surface of the motor panel is preferably formed flat. The supporting surface of the motor panel preferably forms a base area of the motor panel or a part of it. The base of the motor panel is in particular formed closed.

Preferably, the motor panel consists entirely or partly of a thermally conductive material. In particular, the motor panel, at least in the area of its supporting surface, consists of a thermally conductive material. Preferably, the base of the motor panel, preferably at least in the area of its supporting surface, consists of a thermally conductive material.

The fan arrangement arranged on the end face can advantageously be operated independently or separately from the motor. It is thereby ensured that a continuous cooling air flow can be maintained on the housing even at lower motor rotational speeds.

The fan arrangement and/or the motor can advantageously be detached from the motor housing. This makes assembling and disassembling the drive arrangement easier. In particular, the cooling system or cooling device for the drive arrangement is therefore independent from the motor deployed.

The motor housing on its one (first) end face is advantageously connected in a detachable manner to the fan arrangement. On its other end face the motor housing is preferably connected to a motor flange of the motor, wherein the connection between the motor housing and the motor flange is in particular detachable. Preferably, the mechanical connection between the motor and the motor housing and/or the mechanical mounting of the motor on the motor housing is/are only effected by the connection of the motor flange to the motor housing, so that the transfer of vibrations occurring during operation of the motor to the electronic components arranged in the motor panel can be reduced. Such vibrations occur, for example, when a braking device for the motor shaft is actuated and/or released. The motor flange is preferably a radial motor flange.

The electric motor in particular comprises a motor shaft which can be rotated about a rotational axis, the motor shaft preferably being pivot-mounted about the rotational axis on or in the motor flange. In addition, the electric motor has a stator, which preferably is firmly connected to the motor flange, and a rotor which preferably can be rotated about the rotational axis and in particular comprises the motor shaft. Preferably, the electric motor has a bearing end plate, on or in which the motor shaft at an axial distance from the motor flange can be pivot-mounted about the rotational axis. The bearing end plate is preferably firmly connected to the stator which in particular extends in the axial direction from the motor flange up to the bearing end plate. Preferably, the rotor, the stator and the bearing end plate are not in direct mechanical contact with the motor housing, so that the transfer of vibrations from the motor to the motor housing can be reduced. Preferably, the electric motor is therefore only mounted and/or suspended by means of the motor flange on one side on the motor housing.

The rotational axis of the motor shaft in particular defines the axial direction. The radial direction in particular runs perpendicularly to the axial direction.

The motor housing preferably has a marked longitudinal direction which in particular runs in the axial direction or defines it. Preferably, the motor housing is formed as or substantially as a body of revolution. In particular, the motor housing is hollow-cylindrically formed or substantially hollow-cylindrically formed.

According to one preferred embodiment of the invention, an annulus, which surrounds the electric motor and can be flowed through by the cooling air flow, is provided in the motor housing. It is thereby ensured that the location of the greatest heat source, namely the motor housing, is struck in a targeted and channelled way, which results in optimum cooling. The annulus is preferably formed closed or substantially formed closed, in particular with regard to its radially inner and/or radially outer peripheral surface. However, preferably, air outlets are provided in the motor housing, particularly in the area of the motor flange. Preferably, the motor housing comprises at least one wall surrounding the electric motor at a radial distance, wherein the annulus is provided between the electric motor and the wall. The wall is preferably formed by the outer housing wall of the motor housing. Preferably, the wall forms the radially outer peripheral surface of the annulus. The air outlets are preferably provided in the wall.

Bars are advantageously provided in the annulus, which extend in the radial and/or in the axial direction and form lateral boundaries of flow channels. In particular, one of the flow channels in each case runs between two adjacent bars. The flow channels preferably extend in the axial direction. Preferably, the motor housing comprises the bars. Additionally or alternatively, however, the bars can also comprise protruding cooling fins, arranged on the outside of the motor or stator, which in particular protrude radially or obliquely. According to one embodiment of the invention, the motor housing hence forms an outer casing covering the cooling fins. The motor housing can therefore be designed as a fan housing.

According to a further embodiment of the invention, the motor housing comprises a double wall having walls which are arranged at a radial distance from one another and surround the electric motor, between which walls the annulus runs which is preferably sub-divided by the bars into the flow channels. Preferably, for this purpose, the motor housing is designed as, or at least in certain areas is designed as, a double-walled hollow cylinder.

Preferably, the bars extend in the radial direction between the two walls. The radially outer wall of the double wall is preferably formed by the outer housing wall of the motor housing and the radially inner wall of the double wall preferably forms an inner housing wall of the motor housing. The two walls of the double wall are preferably arranged coaxially. With this arrangement, in particular the stator-rotor arrangement of the electric motor is provided within the double-walled hollow cylinder or the radially inner wall of the double wall, preferably without interposing a further housing. Nevertheless, a further housing, e.g. an electric motor housing, can be interposed. The radially outer wall of the double wall preferably comprises or forms the radially outer peripheral surface of the annulus. The radially inner wall of the double wall preferably comprises or forms the radially inner peripheral surface of the annulus.

With the double-walled design of the motor housing, the radial distance between the two walls of the double wall can vary in the axial direction. Preferably, the radial distance between the two walls of the double wall reduces with an increasing axial distance from the fan, so that the radial distance between the two walls is preferably greatest in the area of the fan. By means of this special flow guidance, the area flowed through becomes smaller as the distance from the fan increases, wherein the pressure, however, despite decreasing speed, is maintained. The aerodynamic pressure loss, which occurs when the cooling air flows in the annulus and between the bars, is therefore kept as small as possible. The reduction of the radial distance between the two walls of the double wall with an increasing axial distance from the fan can be continuous or non-continuous. In particular, the reduction of the radial distance occurs along a longitudinal contour, increasing in the direction of the outer housing wall or the radially outer wall of the double wall, which is preferably formed by the radially inner wall of the double wall or is provided on it. The inner diameter of the outer housing wall or the radially outer wall of the double wall preferably does not change in the axial direction. The outer diameter of the inner housing wall or the radially inner wall of the double wall preferably changes in the axial direction, preferably according to the longitudinal contour.

The heat sink is advantageously designed as a flange-like radial elevation extending in the axial direction with the preferably flat supporting surface for the motor panel. The motor housing preferably consists of a thermally conductive material. In particular, the motor housing consists of metal, such as e.g. steel, aluminium or grey cast iron. In addition, the heat sink preferably consists of a thermally conductive material. In particular, the heat sink consists of metal, such as e.g. steel, aluminium or grey cast iron. The motor housing and the heat sink can consist of different materials. Preferably, however, the motor housing and the heat sink are manufactured from the same material. Particularly advantageously, the motor housing and the heat sink are produced as a single part, preferably as a cast part, which can be achieved cost-effectively. This formation is particularly appropriate for the double-walled design of the motor housing.

The detachable connection between the motor housing and the heat sink preferably comprises both one, or at least one, mechanical and one, or at least one, electrical connection. The mechanical connection advantageously has at least one screwed connection and/or one plug-in connection and/or one snap-in connection. The electrical connection, which preferably has electrical connection lines between the motor panel and the electric motor, is advantageously designed as an electrical plug-in connection. The electrical connection preferably also comprises electrical connection lines between a superordinate control device of the drive arrangement and the electric motor and/or the motor panel. The control device can comprise a supply unit which preferably supplies the electrical components of the drive arrangement with electric power. Preferably, the control device is arranged remote from the motor panel.

The supporting surface of the motor panel and/or the supporting surface of the heat sink preferably has/have a thermally conductive coating, so that the heat losses in the motor panel are dissipated better. Thermally conductive paste or thermally conductive film can e.g. be used as the thermally conductive coating.

The electronic components are preferably electrical power and/or control components. The electronic components in particular comprise electrical capacitors and transistors which are preferably to be thermally separated from one another. The separation can, for example, be achieved by an insulation layer or more advantageously by an extended spatial gap between the components, in particular between the capacitors and the transistors. The capacitors are preferably formed by electrolyte capacitors (ELKOS). The transistors are preferably power transistors. In particular, the transistors are formed by IGBTs.

The extended gap between the electronic components or the extended gap between the capacitors and the transistors, with which a longer heat flow path is associated, is advantageously achieved via one, or at least one, elevation and depression of the motor panel base. Additionally or alternatively, the base of the motor panel preferably has a plurality of elevations which are formed by a thermally conductive material and in particular extend right up to the preferably flat supporting surface of the motor panel. These elevations preferably form cooling elements for at least one part of the electronic components, in particular for the transistors, and are preferably in thermoconducting contact with them. The flat (planar) supporting surface of the motor panel enables an optimum transfer of heat to the heat sink. Preferably, depressions are provided in the motor panel base between the elevations. The elevations and/or depressions are in particular arranged or provided on the side of the motor panel base facing away from the heat sink. The supporting surface of the motor panel is in particular provided on the side of the motor panel base facing the heat sink. Preferably, the motor panel base forms a material unit with the elevations. The elevation or elevations is or are preferably horizontal. The depression or depressions is or are preferably horizontal.

The capacitors, which can produce a lot of heat, are advantageously provided with one or a plurality of additional cooling devices. The capacitors are preferably arranged on the side edge of the motor panel in a pocket-shaped projection of the motor panel base in the direction of the motor housing. The projection preferably, at the same time, serves as a further heat sink. On the side edge of the motor panel, at the place where the capacitors are installed, more additional heat sinks, e.g. in the form of cooling fins, which are oriented away from the lateral motor panel wall, can be provided. Additionally, active cooling elements, such as e.g. Peltier elements or other activatable cooling elements, can be provided between the heat sinks and the capacitors.

A side edge of the projection oriented inwards forms a channel with an opposing side edge of the elevation or of one of the elevations, which channel, according to a further embodiment of the invention, can be used for dissipating heat. This channel can advantageously be cooled using a partial air flow of the fan arrangement for the motor housing. For this purpose, the motor housing preferably has a radial opening in the area of the heat sink and the capacitors, through which radial opening, possibly via suitable deflection elements, a partial air flow of the fan is conducted outwards to the projection and the channel in the motor panel base. In this way, local convective cooling of the capacitors occurs.

In a further advantageous embodiment of the drive arrangement, a second motor panel is provided with a second heat sink, wherein both the two motor panels and the two heat sinks are preferably respectively arranged diametrically opposite one another. The second heat sink is firmly connected to the motor housing and the second motor panel is connected to the second heat sink in a detachable manner. This arrangement has the advantage that there is redundancy in the case of failure of one of the motor panels. The second heat sink is e.g. connected to the motor housing in a force-fit and/or form-fit and/or firmly bonded manner. Preferably, the second heat sink forms a material unit with the motor housing.

The drive arrangement is preferably arranged on or in a rotor of a wind turbine which can be rotated about a rotor axis. In particular, the rotor comprises a rotor hub and at least one rotor blade, which extends away from the rotor hub along a blade axis running transverse or substantially transverse to the rotor axis. The rotor blade is preferably mechanically coupled to the drive arrangement according to the invention and can be rotated about the blade axis by means of this drive arrangement. The rotor can in particular be rotated about the rotor axis by wind power.

The invention further relates to a cooling device for an electric drive arrangement according to the invention. In particular, the invention relates to a cooling device for an electric drive arrangement which comprises an electric motor and electronic components for controlling and/or regulating the electric motor, having a motor housing, in which the electric motor is arranged, a fan arrangement arranged on an end face of the motor housing and comprising a fan, by means of which a cooling air flow dissipating heat losses of the electric motor can be generated, and at least one box-shaped motor panel, which rests on the motor housing and accommodates the electronic components, wherein heat generated when the electronic components are in operation can be discharged by means of the motor panel to a heat sink which is in thermoconducting contact with the motor panel. The cooling device according to the invention can be further developed according to all the embodiments explained in connection with the electric drive arrangement according to the invention. In particular, the motor panel is attached in a detachable manner to the heat sink which is preferably firmly connected to the motor housing, so that by interconnecting the heat sink the motor panel is connected in a separable manner to the motor housing.

According to one embodiment of the invention, the electric drive arrangement according to the invention is provided for a blade angle adjustment drive (pitch drive) of a wind turbine. The invention therefore also relates to a blade angle adjustment drive for adjusting, in particular for adjusting at an appropriate angle, one or a plurality of rotor blades about the respective blade axis for a wind turbine for generating electric power, wherein the rotor blade or rotor blades extends or extend transverse to the rotor axis, and wherein the blade angle adjustment drive comprises one, at least one or a plurality of electric drive arrangements according to the invention. The rotor blade or rotor blades can preferably be rotated about its or their respective blade axis by means of the electric motor of the or the respective electric drive arrangement. The blade angle adjustment drive according to the invention can be further developed according to all the embodiments explained in connection with the electric drive arrangement according to the invention.

Adjustment at an appropriate angle in particular means adjusting, i.e. rotating, the rotor blade or rotor blades about its or their respective blade axis, preferably corresponding to an angle or angle of attack which is pre-specified in each case.

The invention is explained below with the aid of a preferred embodiment with reference to the figures:

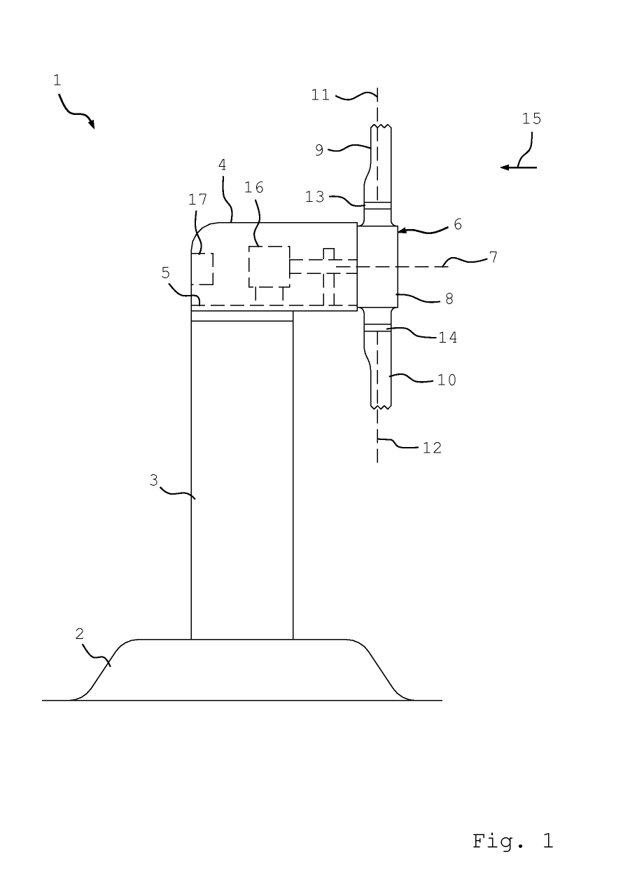

FIG. 1 shows a schematic illustration of a wind turbine having an electric drive arrangement for adjusting the blade angle of a rotor blade,

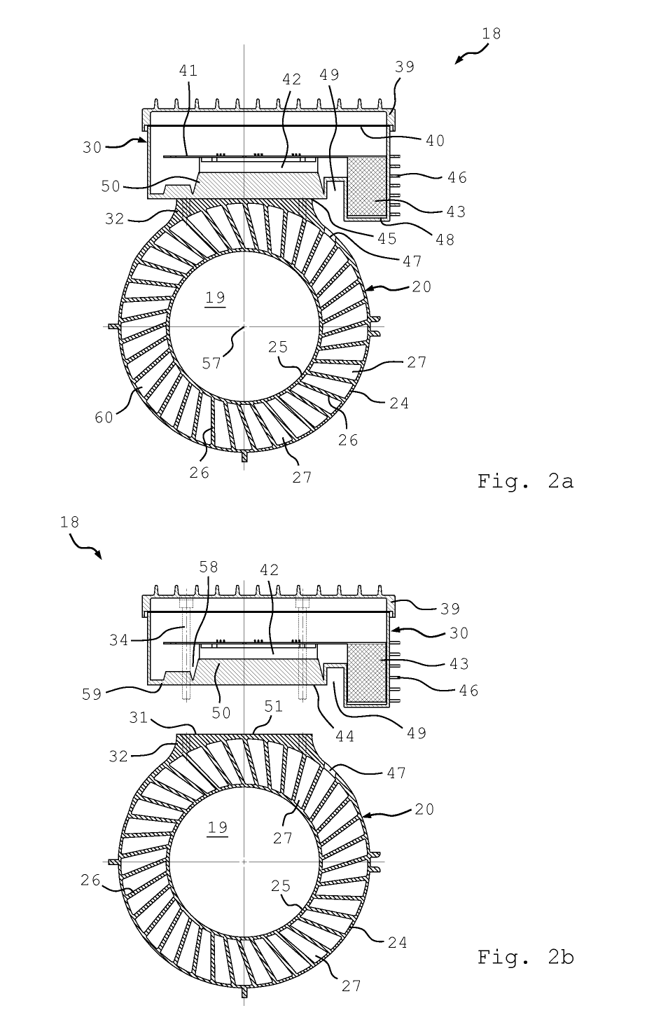

FIG. 2a shows a cross section through a drive arrangement according to an embodiment of the invention with the motor panel attached,

FIG. 2b shows a cross section through the drive arrangement according to FIG. 2a with the motor panel detached,

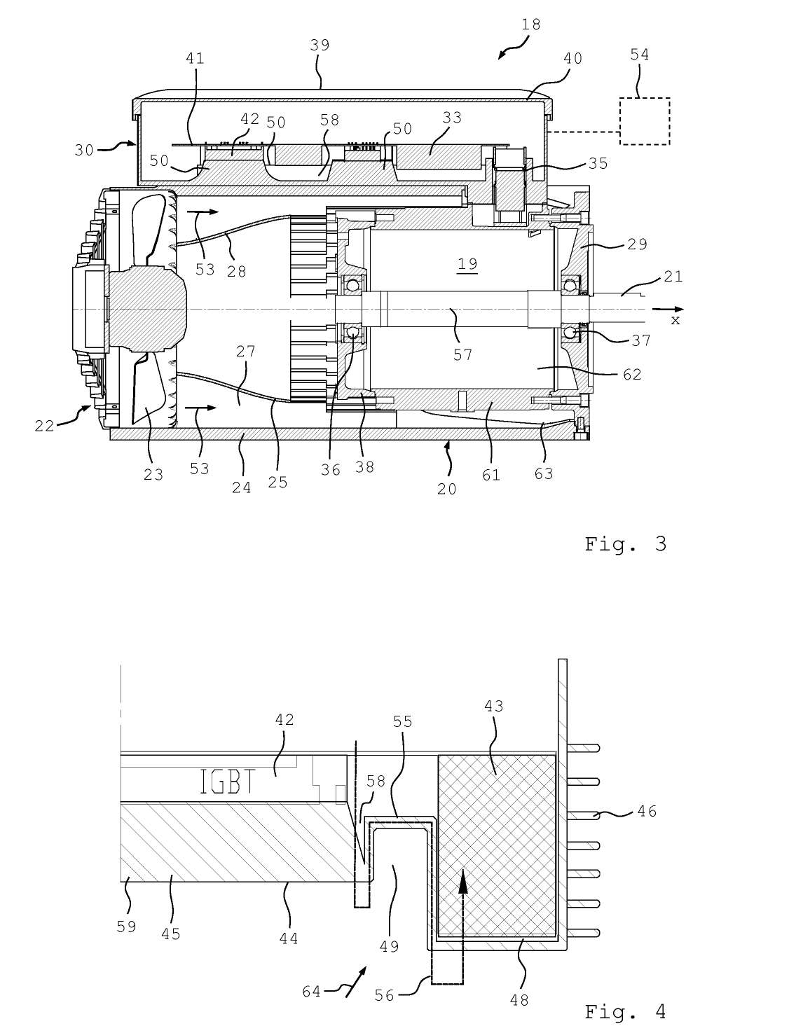

FIG. 3 shows a longitudinal section through the drive arrangement according to FIG. 2a,

FIG. 4 shows an enlarged detail from FIG. 2a,

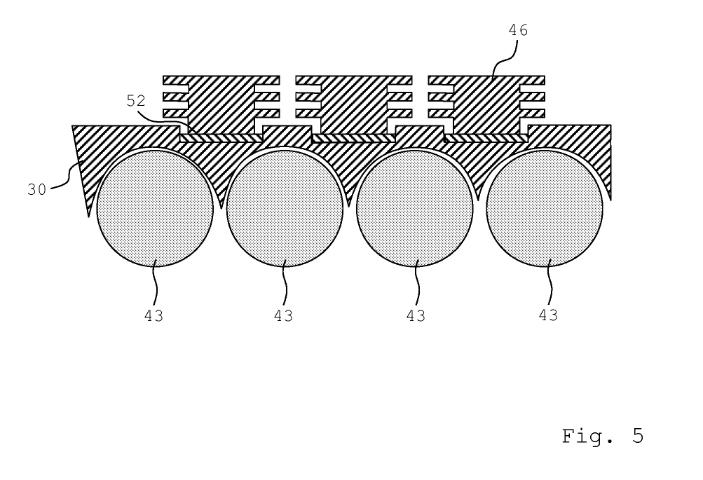

FIG. 5 shows an alternative to the capacitor cooling shown in FIG. 4.

A wind turbine 1 can be seen from FIG. 1, wherein a tower 3 standing on a base 2 is connected to a nacelle 4 at its end facing away from the base 2. In the nacelle 4, a machine support 5 is arranged, on which a rotor 6 is pivot-mounted about a rotor axis 7, the rotor 6 having a rotor hub 8 and rotor blades 9 and 10 connected to it, which each can be rotated about their blade axis 11, 12 relative to the rotor hub 8. Each rotor blade 9, 10 is mechanically coupled to an adjustment drive 13, 14, by means of which the respective rotor blade 9, 10 can be rotated about the corresponding blade axis 11, 12. The rotor 6 is mechanically coupled to an electric generator 16 which is arranged in the nacelle 4 and is attached to the machine support 5 and largely converts the wind power 15 acting on the individual rotor blades into electric power. A wind turbine control 17 is provided to operate the wind turbine 1 in a controlled way, by means of which, amongst other things, the adjustment drives 13 and 14 are controlled.

Each of the adjustment drives 13, 14 comprises an electric drive arrangement 18 as a fundamental component, which can be seen as a cross section diagram from FIGS. 2a and 2b and as a longitudinal section illustration from FIG. 3.

The drive arrangement 18 comprises an electric motor 19 which is coaxially surrounded by a motor housing 20. As can be seen from FIG. 3, a fan arrangement 22, which is driven independently from the motor 19 and is not linked to the motor shaft 21, is provided on an end face of the motor housing 20. It is hereby ensured that the required cooling effect for the drive arrangement 18 is maintained even at a low rotational speed of the motor shaft 21. A cooling air flow produced by the fan 23 of the fan arrangement 22 dissipates the heat losses of the motor 19 via the motor housing 20. The cooling air flow is represented by the arrow 53 and can flow in the direction of this arrow or in the opposite direction. According to the embodiment, however, the cooling air flow flows in the direction of the arrow 53. In the area of the end of the motor housing 20 facing away from the fan 23, outlets 63 are provided, through which the cooling air flow 53 flows out of the motor housing 20. The fan arrangement 22 and the motor 19 are arranged separate from one another. The motor 19 is slid into the motor housing 20 and in particular can be replaced, so that for disassembly the motor 19 can be slid out of the housing 20. Therefore, the motor housing 20 preferably forms a fan housing.

In the illustration of FIGS. 2a and 2b, the motor housing 20 is designed as a double-walled hollow cylinder with walls 24 and 25 arranged at a radial distance from one another, wherein the wall 24 forms an outer housing wall and the wall 25 forms an inner housing wall. Bars 26, extending in the radial direction and in the axial direction and inclined with respect to the radial direction, are provided between the two walls 24 and 25.

The annulus 60 is sub-divided between the walls 24 and 25 into a plurality of flow channels 27 by the bars 26, wherein in each case two adjacent bars 26 form lateral boundaries for one of the flow channels 27. The angle of inclination of the bars 26 with respect to the radial direction is contrary to the rotational direction of the fan 23, so that the air circulating through the rotation of the fan 23 can be channelled into the flow channels 27 in an optimum way.

It can be seen from FIG. 3 that the radial distance between the two walls 23 and 24 of the housing 20 changes in the axial direction. The radial distance is at its greatest in the area of the fan arrangement 22, so that then, following a radially increasing longitudinal contour 28 of the inner housing wall 25, the smallest radial distance is assumed at the motor flange 29 of the opposite end face of the drive arrangement 18. By means of this special flow guidance, the area flowed through becomes smaller as the distance from the fan 23 increases, wherein the pressure, in particular even with decreasing flow speed, is substantially maintained. The aerodynamic pressure loss, which occurs when the cooling air flows in the flow channels 27, is therefore kept as low as possible.

Electronic power and control components 33, which are arranged in a control box 30 which hereinafter is referred to as the motor panel, are provided for electrically controlling and/or regulating and for supplying power to the drive arrangement 18. As can in particular be seen from FIG. 2a, the motor panel 30 rests on the outer housing wall 24 of the housing 20, namely on a supporting surface 31 of a heat sink 32 for dissipating the heat generated when the electronic components 33 are in operation. To improve the heat transfer between the motor panel 30 and the heat sink 32, the supporting surface 31 thereof is preferably provided with a thermoconducting coating 51 which e.g. can be formed by a thermally conductive paste or a thermally conductive film. The heat sink 32 is permanently firmly connected to the housing 20. According to the embodiment, the heat sink 32 is an integral component of the housing 20 and forms a flange-like radial elevation, extending in the axial direction of the housing 20, with the flat supporting surface 31 for the motor panel 30.

As can be seen from FIG. 2b, the motor panel 30 can be mechanically detached from the heat sink 32, wherein the connection between the motor panel 30 and the heat sink 32 is formed by a detachable screwed connection 34. Alternatively or additionally, the connection can also be formed by mechanical plug-in and/or snap-in connections.

The motor 19 comprises a motor flange 29, a bearing end plate 38, a stator 61 and a rotor 62, having a motor shaft 21 which is pivot-mounted about a rotational axis 57 on the bearing end plate 38 on a bearing 36 and on the motor flange 29 on a bearing 37. The stator 61 extends in the axial direction between the motor flange 29 and the bearing end plate 38 and is both firmly connected to the motor flange 29 and to the bearing end plate 38. The bearing end plate 38 is arranged on an end face of the motor 19 or stator 61 facing the fan arrangement 22, on the other end face of which the motor flange 29 is arranged. The rotational axis 57 of the motor shaft 21 defines the axial direction x. The radial direction runs perpendicularly to the axial direction.

The motor housing 20 is in particular connected in a detachable manner on its first end face to the fan arrangement 22 and on its other end face to the motor flange 29 of the motor 19. The motor 19 is thereby, in mechanical terms, only connected to the motor housing 20, or mounted on it, via the connection between the motor housing 20 and the motor flange 29, so that neither the stator 61 or the bearing end plate 38 have a direct contact to the motor housing 20.

The electrical connection between the motor panel 30 and the motor 19 is implemented as an electrical plug-in connection 35. This plug-in connection 35 is provided in the area of the motor flange 29 in FIG. 3. This connection also comprises the connection to a superordinate and only schematically indicated control and regulating device 54 which is preferably formed by the wind turbine control 17.

The motor panel 30 is sealed by a lid 39 on which cooling fins are arranged. The motor panel 30 is in particular sealed on all sides. Moisture and dirt are largely prevented from penetrating by means of a seal 40 arranged between the box-shaped motor panel 30 and its lid 39. The panel 30 is therefore to be regarded as a “black box” which is replaced in the case of malfunctions or failure.

Opening the motor panel 30 is no longer necessary due to the detachable connection to the housing 20. As a result, the electronic components 33 can be fitted very compactly and cost-effectively without having to take accessibility into account in the event of a functional failure. As can be seen from FIG. 2a, the components 33 are arranged inverted on a printed circuit board 41. In particular, the components 33 are applied fully automatically to the printed circuit board beforehand, which is then inserted inverted into the motor panel 30. Preferably, the components 33 are arranged on a plurality of printed circuit boards arranged parallel one above the other.

The electronic components 33 in particular comprise transistors 42, which here are formed as IGBTs, and capacitors 43, which here are formed as electrolyte capacitors (ELKOS), wherein the latter in particular have a high amount of heat loss in operation and therefore additional cooling devices are appropriate. The base 59 of the motor panel 30 is not flat but has depressions 58 and elevations 50 on its side facing away from the heat sink 32, i.e. within the motor panel 30, wherein the elevations 50 consist of a thermally conductive and/or heat-absorbing material 45. The base 59, on its side facing the heat sink 32, has a flat supporting surface 44 which is connected to the flat supporting surface 31 of the heat sink 32 in a thermoconducting manner. According to the embodiment, the elevations 50 form a material unit with the base 59, so that the base 59 consists of the material 45. The elevations 50 are arranged directly under the transistors 42 which preferably are in thermoconducting contact with the elevations 50, so that the heat losses of the transistors 42 are conducted via the material 45 onto the heat sink 32.

FIG. 4, in a detail illustration of the right side edge of FIG. 2a or 2b, shows that the electronic power and control elements 33 are thermally separated from one another. The separation is brought about by means of an extended spatial gap between the capacitors 43 and the transistors 42, wherein the base 59 has a horizontal elevation 55 within this gap. The extended spatial gap is made clear by the arrow 56. Additional separate cooling is provided for the capacitors 43 due to their high heat losses. To this end, the capacitors 43 are arranged on the right side edge of the motor panel 30 in a pocket-shaped, downwardly oriented projection 48 of the motor panel base 59. The projection 48 not only serves to accommodate the capacitors 43 but also to passively cool them and hence forms an additional separate cooling device for the capacitors 43. The cooling effect is improved further by protruding cooling fins 46 on the side edge of the motor panel 30, which are attributed to the additional separate cooling device. The horizontal elevation 55 is provided between the projection 48 and the supporting surface 44, over which the elevations 50 are arranged. In addition, the elevation 55 abuts on one of the depressions 58.

Additionally or alternatively, as can be seen from FIG. 2a, the capacitors 43 can, depending on the heat losses arising, be cooled via a branched-off partial air flow 64 of the fan arrangement 22 of the motor 19. For this purpose, the outer housing wall 24 of the motor housing 20 has a radial opening 47 in the area of the heat sink 32 and of the projection 48 or of the capacitors 43. The opening 47 leads into the annulus 60, in particular into one of the flow channels 27, so that a partial air flow 64 can be branched-off from the cooling air flow 53. Side walls of the projection 48 and of the horizontal elevation 55 delimit a channel 49, which is open towards the motor housing 20 and extends in the axial direction, into which channel 49 the partial air flow 64 flowing out of the opening 47 is channelled and hence dissipates heat losses of the capacitors 43.

FIG. 5 shows an alternative design for additional cooling of the capacitors 43 via active cooling elements 52 which are provided in the lateral outer wall of the motor panel 30 between the mounting of the capacitors 43 and the laterally protruding cooling fins 46. The active cooling elements 52 can e.g. comprise Peltier elements.

### LIST OF REFERENCE SYMBOLS

1 Wind turbine
2 Base
3 Tower
4 Nacelle
5 Machine support
6 Rotor
7 Rotor axis
8 Rotor hub
9 Rotor blade
10 Rotor blade
11 Blade axis
12 Blade axis
13 Adjustment drive
14 Adjustment drive
15 Wind power
16 Generator
17 Wind turbine control
18 Drive arrangement
19 Electric motor
20 Housing
21 Motor shaft
22 Fan arrangement
23 Fan
24 Outer housing wall
25 Inner housing wall
26 Bar
27 Flow channel
28 Longitudinal contour
29 Motor flange
30 Motor panel
31 Supporting surface
32 Heat sink
33 Electronic components
34 Screwed connection
35 Electrical plug-in connection
36 Bearing
37 Bearing
38 Bearing end plate
39 Lid
40 Seal
41 Printed circuit board
42 Transistor (IGBT)
43 Capacitor (ELKO)
44 Supporting surface
45 Thermally conductive material
46 Cooling fins
47 Radial opening
48 Projection
49 Channel
50 Elevation
51 Thermally conductive coating
52 Cooling element
53 Cooling air flow
54 Control and regulating device
55 Horizontal elevation of the base surface
56 Arrow
57 Rotational axis of the motor shaft
58 Depression
59 Base of the motor panel
60 Annulus
61 Stator of the motor
62 Rotor of the motor
63 Outlet for the cooling air flow
64 Partial air flow
x Axial direction

1-28. (canceled)

29. An electric drive arrangement comprising:
an electric motor arranged in a motor housing;
a fan positioned adjacent to an end face of the motor housing and generating a cooling air flow for dissipating heat losses of the electric motor;
an electronic controller for controlling or regulating the electric motor; and
a box-shaped motor panel supported on the motor housing and accommodating the electronic controller;
wherein heat generated by the electronic controller during operation can be discharged by means of the motor panel to a heat sink which is in thermal conducting contact with the motor panel.

30. The electric drive arrangement according to claim 29, wherein the motor panel is attached in a detachable manner to the heat sink which is firmly connected to the motor housing, so that by interconnecting the heat sink the motor panel is connected in a separable manner to the motor housing.

31. The electric drive arrangement according to claim 29, wherein the box-shaped motor panel comprises a plurality of sides, and the motor panel is adequately sealed on each side for largely preventing to moisture and dirt from penetrating the motor panel.

32. The electric drive arrangement according to claim 29, wherein the fan is detachably mounted to the motor housing and can be operated separately from the electric motor.

33. The electric drive arrangement according to claim 29, the fan is detachably mounted to a first end face of the motor housing and a motor flange is mounted on a second end face of the motor housing.

34. The electric drive arrangement according to claim 29, wherein the motor housing surrounds the electric motor to define an annulus allowing the cooling air flow therethrough.

35. The electric drive arrangement according to claim 34, wherein the motor housing comprises a casing of protruding cooling fins arranged on the outside of the electric motor.

36. The electric drive arrangement according to claim 34, wherein the motor housing comprises a double wall having first and second walls arranged at a radial distance from one another surrounding the electric motor, the annulus being defined between the first and second walls.

37. The electric drive arrangement according to claim 34, further comprising bars disposed in the annulus and extending in the radial and axial directions to form lateral boundaries of flow channels.

38. The electric drive arrangement according to claim 37, wherein the bars are curved or inclined with respect to the radial direction.

39. The electric drive arrangement according to claim 37, wherein the radial extension of the bars decreases with an increasing axial distance from the fan arrangement.

40. The electric drive arrangement according to claim 29, wherein the heat sink comprises a flange-like radial elevation extending in the axial direction of the housing and having a flat surface which forms a supporting surface for the motor panel.

41. The electric drive arrangement according to claim 29, wherein the heat sink forms a material unit with an outer housing wall of the motor housing.

42. The electric drive arrangement according to claim 29, wherein the motor panel is mechanically connected and electrically connected in a separable manner to the heat sink.

43. The electric drive arrangement according to claim 42, wherein the separable mechanical connection is selected from the group comprising a screwed connection, a plug-in connection, snap-in connection and combinations thereof.

44. The electric drive arrangement according to claim 42, wherein the separable electrical connection comprises a connection between the motor panel and the motor housing and a connection to a remotely arranged, superordinate control device.

45. The electric drive arrangement claim 29, wherein a supporting surface of the heat sink, which is in thermal conducting contact with the motor panel, comprises a thermally conductive coating.

46. The electric drive arrangement according to claim 29, wherein the electronic controller comprises electronic components including capacitors and transistors which are thermally separated from one another.

47. The electric drive arrangement according to claim 46, wherein the capacitors and the transistors are thermal separation by an extended, spatial gap therebetween.

48. The electric drive arrangement according to claim 46, wherein the capacitors are arranged in a pocket-shaped projection of a motor panel base, the projection being arranged on the motor panel side edge and oriented towards the motor housing such that the projection provides an additional heat sink for the capacitors.

49. The electric drive arrangement according to claim 48, wherein in the pocket-shaped projection comprises active cooling elements on the outside of the side wall of the motor panel in the area of the mounting of the capacitors.

50. The electric drive arrangement according to claim 46, wherein the capacitors are cooled by a partial flow of the cooling air flow of the fan arrangement.

51. The electric drive arrangement according to claim 50, wherein the partial air flow is branched off from the cooling air flow by a radial outlet in the outer housing wall of the motor housing in the area of the heat sink, and wherein the partial air flow is conducted into a channel which is delimited by side walls of the pocket-shaped projection and an elevation of the housing panel base.

52. The electric drive arrangement according to claim 29, wherein the base of the motor panel has elevations which are formed by a thermally conductive material and extend right up to a flat supporting surface of the motor panel.

53. The electric drive arrangement according to claim 29, further comprising a second heat sink firmly connected to the motor housing, and a second motor panel connected to the second heat sink in a thermal conducting and detachable manner, wherein both the two motor panels and the two heat sinks are respectively arranged diametrically opposite one another.

54. The cooling device for an electric drive arrangement having an electric motor and electronic components for controlling and regulating the electric motor, the cooling device comprising:
a motor housing in which the electric motor is arranged;
a fan positioned adjacent an end face of the motor housing and generating cooling air flow for dissipating heat losses of the electric motor; and
a box-shaped motor panel supported on the motor housing and accommodating electronic components for controlling or regulating the electric motor;
wherein heat generated during operation of the electronic components can be discharged by means of the motor panel to a heat sink which is in thermal conducting contact with the motor panel.

55. The cooling device according to claim 54, wherein the motor panel is attached in a detachable manner to the heat sink which is firmly connected to the motor housing, so that by interconnecting the heat sink the motor panel is connected in a separable manner to the motor housing.

56. A blade angle adjustment drive for adjusting at least one rotor blade for a wind turbine about a blade axis for generating electric power, wherein the rotor blades extend transverse to a rotor axis, the blade angle adjustment drive:
an electric motor arranged in a motor housing;
a fan positioned adjacent to an end face of the motor housing and generating a cooling air flow for dissipating heat from the electric motor;
an electronic controller for controlling or regulating the electric motor; and
a box-shaped motor panel supported on the motor housing and accommodating the electronic controller;
wherein heat generated during operation of the electronic controller can be discharged by means of the motor panel to a heat sink which is in thermal conducting contact with the motor panel.
